(19) United States
(12) Patent Application Publication
(10) Pub. No.: US 2019/0172453 A1
(43) Pub. Date: Jun. 6, 2019

(54) SEAMLESS ADVISOR ENGAGEMENT

(71) Applicant: GM GLOBAL TECHNOLOGY OPERATIONS LLC, Detroit, MI (US)

(72) Inventors: Xu Fang Zhao, LaSalle (CA); Cody R. Hansen, Shelby Township, MI (US); Dustin H. Smith, Auburn Hills, MI (US); Gaurav Talwar, Novi, MI (US)

(73) Assignee: GM GLOBAL TECHNOLOGY OPERATIONS LLC, Detroit, MI (US)

(21) Appl. No.: 15/833,126

(22) Filed: Dec. 6, 2017

(51) Int. Cl. G10L 15/22; G06F 17/30; G10L 15/08; G10L 15/20; B60R 16/037

(52) U.S. Cl. CPC G10L 15/22; G06F 17/30876; G06F 17/3053; G01C 21/3608; G10L 15/20; B60R 16/0373; G10L 2015/223; G10L 15/08

(57) ABSTRACT

In various embodiments, methods, systems, and vehicles are provided. The system includes a microphone and a processor. The microphone is configured to obtain a request from a user. The processor is configured to at least facilitate automatically generating an interpretation of the request; automatically determining an automated processing recognition score for the request; and automatically engaging a human advisor to further process the request, based on the determined automated processing recognition score.

### TECHNICAL FIELD

The technical field generally relates to the field of vehicles and computer applications for vehicles and other systems and devices and, more specifically, to methods and systems for processing user requests using a remote advisor.

### INTRODUCTION

Many vehicles, smart phones, computers, and/or other systems and devices utilize an advisor to provide information or other services in response to a user request. However, in certain circumstances, it may be desirable for improved processing of user requests in certain situations.

Accordingly, it is desirable to provide improved methods and systems for utilize an advisor to provide information or other services in response to a request from a user for vehicles and computer applications for vehicles and other systems and devices. Furthermore, other desirable features and characteristics will become apparent from the subsequent detailed description of exemplary embodiments and the appended claims, taken in conjunction with the accompanying drawings.

### SUMMARY

In one embodiment, a method is provided that includes obtaining, via a microphone, a request from a user; automatically generating, via a processor, an interpretation of the request; automatically determining, via the processor, an automated processing recognition score for the request; and automatically engaging, via instructions provided by the processor, a human advisor to further process the request, based on the determined automated processing recognition score.

Also in one embodiment, the method also includes automatically providing the request and the interpretation, via instructions provided by the processor, to the human advisor for further processing.

Also in one embodiment, the method also includes automatically providing initial information pertaining to the interpretation to the user via instructions provided by the processor; and receiving feedback from the user regarding the initial information; wherein the step of automatically determining the automated processing recognition score includes automatically determining the automated processing recognition score using the feedback.

Also in one embodiment, the method includes automatically determining that engagement of the human advisor is required if the feedback includes the user repeating the request.

Also in one embodiment, the method includes automatically obtaining, via one or more additional sensors, sensor data pertaining to one or more surrounding conditions for the user; wherein the step of automatically determining the automated processing recognition score includes automatically determining the automated processing recognition score based on the one or more surrounding conditions.

Also in one embodiment, the method includes automatically determining that engagement of the human advisor is required if the one or more surrounding conditions represent noise that is greater than a predetermined threshold.

Also in one embodiment, the method includes automatically retrieving, from a memory, a database of user information; wherein the step of automatically generating the interpretation includes automatically generating the interpretation using the user information; and the method further includes: obtaining a revised interpretation from the human advisor; and updating the database of user information based on the revised interpretation.

Also in one embodiment, the steps are implemented at least in part as part of a computer system for a vehicle in which the user is occupied.

In another embodiment, a system is provided that includes a microphone and a processor. The microphone is configured to obtain a request from a user. The processor is configured to at least facilitate automatically generating an interpretation of the request; automatically determining an automated processing recognition score for the request; and automatically engaging a human advisor to further process the request, based on the determined automated processing recognition score.

Also in one embodiment, the processor is further configured to at least facilitate automatically providing instructions to provide the request and the interpretation to the human advisor for further processing.

Also in one embodiment, the processor is further configured to at least facilitate automatically providing instructions to providing initial information pertaining to the interpretation to the user; the microphone is further configured to receive feedback from the user regarding the initial information; and the processor is further configured to at least facilitate automatically determining the automated processing recognition score using the feedback.

Also in one embodiment, the processor is further configured to at least facilitate automatically determining that engagement of the human advisor is required if the feedback includes the user repeating the request.

Also in one embodiment, the system further includes one or more additional sensors configured to at least facilitate automatically obtaining sensor data pertaining to one or more surrounding conditions for the user; wherein the processor is further configured to at least facilitate automatically determining the automated processing recognition score based on the one or more surrounding conditions.

Also in one embodiment, the processor is further configured to at least facilitate automatically determining that engagement of the human advisor is required if the one or more surrounding conditions represent noise that is greater than a predetermined threshold.

Also in one embodiment, the system further includes a memory configured to store a database of user information; wherein the processor is further configured to at least facilitate: automatically retrieving, from the memory, the database of user information; automatically generating the interpretation using the user information; obtaining a revised interpretation from the human advisor; and updating the database of user information based on the revised interpretation.

Also in one embodiment, the system at least in part is implemented as part of a computer system for a vehicle in which the user is occupied.

In another embodiment, a vehicle is provided that includes a passenger compartment for a user; a microphone; and a processor. The microphone is configured to obtain a request from the user. The processor is configured to at least facilitate: automatically generating an interpretation of the request; automatically determining an automated processing recognition score for the request; and automatically engaging a human advisor to further process the request, based on the determined automated processing recognition score.

Also in one embodiment, the processor is further configured to at least facilitate automatically providing instructions to providing initial information pertaining to the interpretation to the user; the microphone is further configured to receive feedback from the user regarding the initial information; and the processor is further configured to at least facilitate: automatically determining the automated processing recognition score using the feedback; and automatically determining that engagement of the human advisor is required if the feedback includes the user repeating the request.

Also in one embodiment, the vehicle also includes one or more additional sensors configured to at least facilitate automatically obtaining sensor data pertaining to one or more surrounding conditions for the user; and the processor is further configured to at least facilitate: automatically determining the automated processing recognition score based on the one or more surrounding conditions; and automatically determining that engagement of the human advisor is required if the one or more surrounding conditions represent noise that is greater than a predetermined threshold.

Also in one embodiment, the vehicle also includes a memory configured to store a database of user information; and the processor is further configured to at least facilitate automatically retrieving, from the memory, the database of user information; automatically generating the interpretation using the user information; obtaining a revised interpretation from the human advisor; and updating the database of user information based on the revised interpretation.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle, a remote server, and a control system for utilizing an advisor to provide information or other services in response to a request from a user, in accordance with exemplary embodiments; and

FIG. 2 is a flowchart of a process for utilizing an advisor to provide information or other services in response to a request from a user, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

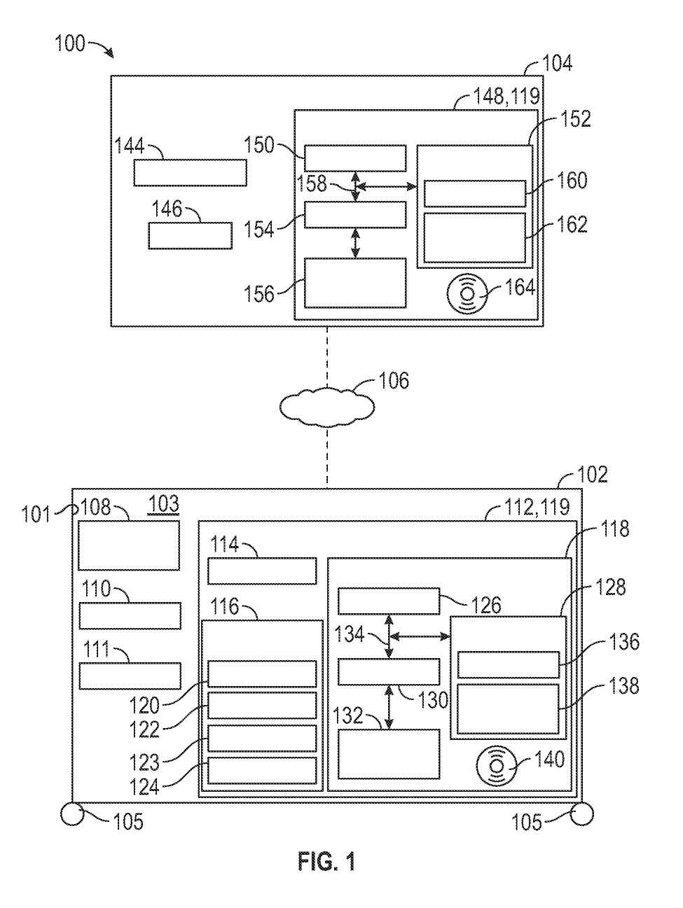

FIG. 1 illustrates a system 100 that includes a vehicle 102 and a remote server 104. As depicted in FIG. 1, the vehicle 102 and the remote server 104 communicate via one or more communication networks 106 (e.g., one or more cellular, satellite, and/or other wireless networks, in various embodiments). In various embodiments, the system 100 includes one or more user request control systems 119 for utilizing an advisor to provide information or other services in response to a request from a user, in accordance with exemplary embodiments.

As depicted in FIG. 1, in various embodiments the vehicle 102 includes a body 101, a passenger compartment (i.e., cabin) 103 disposed within the body 101, one or more wheels 105, a drive system 108, a display 110, one or more other vehicle systems 111, and a vehicle control system 112. In various embodiments, the vehicle control system 112 of the vehicle 102 comprises or is part of the user request control system 119 for utilizing an advisor to provide information or other services in response to a request from a user, in accordance with exemplary embodiments. As depicted in FIG. 1, in various embodiments, the user request control system 119 and/or components thereof may also be part of the remote server 104.

In various embodiments, the vehicle 102 comprises an automobile. The vehicle 102 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the user request control system 119 may be implemented in connection with one or more different types of vehicles, and/or in connection with one or more different types of systems and/or devices, such as computers, tablets, smart phones, and the like and/or software and/or applications therefor.

In various embodiments, the drive system 108 is mounted on a chassis (not depicted in FIG. 10, and drives the wheels 109. In various embodiments, the drive system 108 comprises a propulsion system. In certain exemplary embodiments, the drive system 108 comprises an internal combustion engine and/or an electric motor/generator, coupled with a transmission thereof. In certain embodiments, the drive system 108 may vary, and/or two or more drive systems 108 may be used. By way of example, the vehicle 102 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the display 110 comprises a display screen, speaker, and/or one or more associated apparatus, devices, and/or systems for providing visual and/or audio information, such as map and navigation information, for a user. In various embodiments, the display 110 includes a touch screen. Also in various embodiments, the display 110 comprises and/or is part of and/or coupled to a navigation system for the vehicle 102. Also in various embodiments, the display 110 is positioned at or proximate a front dash of the vehicle 102, for example between front passenger seats of the vehicle 102. In certain embodiments, the display 110 may be part of one or more other devices and/or systems within the vehicle 102. In certain other embodiments, the display 110 may be part of one or more separate devices and/or systems (e.g., separate or different from a vehicle), for example such as a smart phone, computer, table, and/or other device and/or system and/or for other navigation and map-related applications.

Also in various embodiments, the one or more other vehicle systems 111 include one or more systems of the vehicle 102 that may have an impact on a user's providing of audible instructions for the vehicle control system 112 (e.g., to a microphone 120 thereof, discussed below), for example that may generate, represent, or indicate noise surrounding the user (e.g., noise in the cabin 103 of the vehicle 102) and/or Internet connectivity problems and/or other technological impairments, and so on. For example, in certain embodiments, the other vehicle systems 111 may include, by way of example, one or more engines of the vehicle 102, one or more entertainment systems of the vehicle 102, one or more climate control systems of the vehicle 102, one or more Internet connection systems, one or more window systems of the vehicle 102, and so on.

As depicted in FIG. 1, in various embodiments, the vehicle control system 112 includes one or more transceivers 114, sensors 116, and a controller 118. As noted above, in various embodiments, the vehicle control system 112 of the vehicle 102 comprises or is part of the user request control system 119 for utilizing an advisor to provide information or other services in response to a request from a user, in accordance with exemplary embodiments. In addition, similar to the discussion above, while in certain embodiments the user request control system 119 (and/or components thereof) is part of the vehicle 102 of FIG. 1, in certain other embodiments the user request control system 119 may be part of the remote server 104 and/or may be part of one or more other separate devices and/or systems (e.g., separate or different from a vehicle and the remote server), for example such as a smart phone, computer, and so on.

As depicted in FIG. 1, in various embodiments, the one or more transceivers 114 are used to communicate with the remote server 104. In various embodiments, the one or more transceivers 114 communicate with one or more respective transceivers 144 of the remote server 104 via one or more communication networks 106 of FIG. 1.

Also as depicted in FIG. 1, the sensors 116 include one or more microphones 120, other input sensors 122, cameras 123, and one or more additional sensors 124. In various embodiments, the microphone 120 receives inputs from the user, including a request from the user (e.g., a request from the user for information to be provided and/or for one or more other services to be performed). Also in various embodiments, the other input sensors 122 receive other inputs from the user, for example via a touch screen or keyboard of the display 110 (e.g., as to additional details regarding the request, in certain embodiments). In certain embodiments, one or more cameras 123 are utilized to obtain additional input data, for example pertaining to point of interests, such as by scanning quick response (QR) codes to obtain names and/or other information pertaining to points of interest (e.g., by scanning coupons for preferred restaurants, stores, and the like, and/or intelligently leveraging the cameras 123 in a speech and multi modal interaction dialog), and so on.

In addition, in various embodiments, the additional sensors 124 obtain data pertaining to the drive system 108 (e.g., pertaining to operation thereof) and/or one or more other vehicle systems 111 that may have an impact on a user's providing of audible instructions for the vehicle control system 112 to the microphone 120 thereof. For example, in certain embodiments, the additional sensors 124 obtain data with respect to various vehicle systems (that may include, by way of example, one or more drive systems, engines, more entertainment systems, climate control systems, window systems, and so on) that may generate, represent, and/or be indicative of a noise and/or sound level inside the cabin 103 of the vehicle 102 and/or Internet connectivity problems and/or other technological impairments, and so on.

In various embodiments, the controller 118 is coupled to the transceivers 114 and sensors 116. In certain embodiments, the controller 118 is also coupled to the display 110, and/or to the drive system 108 and/or other vehicle systems 111. Also in various embodiments, the controller 118 controls operation of the transceivers and sensors 116, and in certain embodiments also controls, in whole or in part, the drive system 108, the display 110, and/or the other vehicle systems 111.

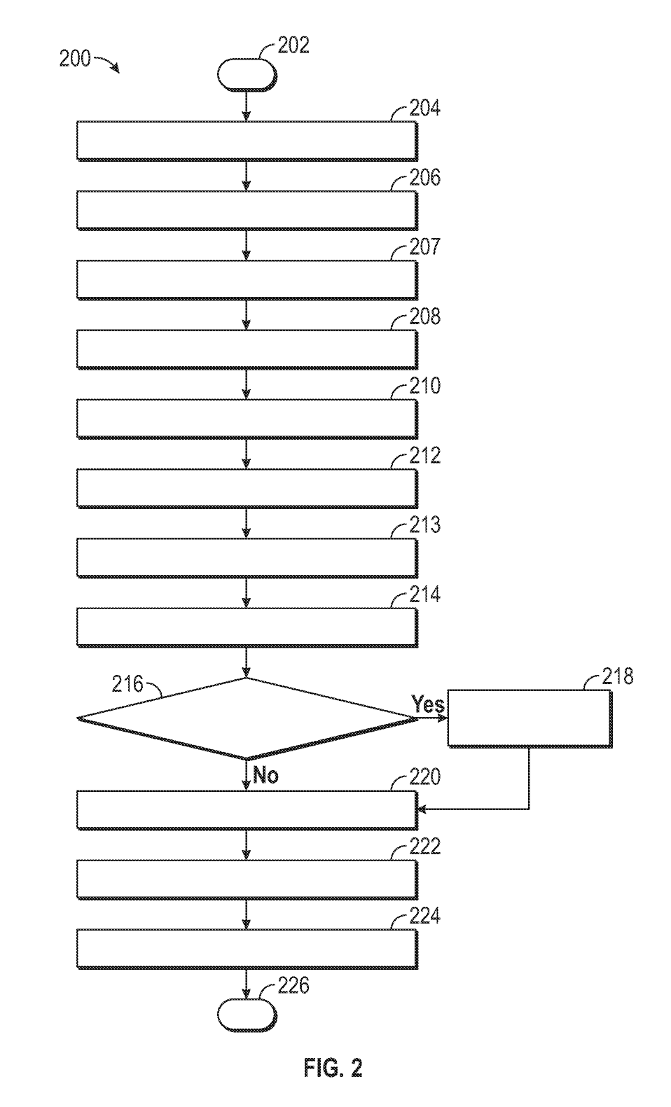

In various embodiments, the controller 118 receives inputs from a user, including a request from the user for information and/or for the providing of one or more other services. Also in various embodiments, the controller 118 generates an interpretation of the request, gathers additional information that may pertain to the request (e.g., sensor data pertaining to noise within the cabin 103, whether the user has repeated the request, user data from a database, and so on, Internet connectivity problems, other technological impairments, and/or the context of the request), determines an automated voice recognition (AVR) score pertaining to the processing of the request, and selectively engages a human advisor to further process the request based on the AVR score. Also in various embodiments, the controller 118 performs these tasks in an automated manner in accordance with the steps of the process 200 described further below in connection with FIG. 2. In certain embodiments, some or all of these tasks may also be performed in whole or in part by one or more other controllers, such as the remote server controller 148 (discussed further below), instead of or in addition to the vehicle controller 118.

As depicted in FIG. 1, the controller 118 comprises a computer system. In certain embodiments, the controller 118 may also include one or more transceivers 114, sensors 116, other vehicle systems and/or devices, and/or components thereof. In addition, it will be appreciated that the controller 118 may otherwise differ from the embodiment depicted in FIG. 1. For example, the controller 118 may be coupled to or may otherwise utilize one or more remote computer systems and/or other control systems, for example as part of one or more of the above-identified vehicle 102 devices and systems, and/or the remote server 104 and/or one or more components thereof.

In the depicted embodiment, the computer system of the controller 118 includes a processor 126, a memory 128, an interface 130, a storage device 132, and a bus 134. The processor 126 performs the computation and control functions of the controller 118, and may comprise any type of processor or multiple processors, single integrated circuits such as a microprocessor, or any suitable number of integrated circuit devices and/or circuit boards working in cooperation to accomplish the functions of a processing unit. During operation, the processor 126 executes one or more programs 136 contained within the memory 128 and, as such, controls the general operation of the controller 118 and the computer system of the controller 118, generally in executing the processes described herein, such as the process 200 described further below in connection with FIG. 2.

The memory 128 can be any type of suitable memory. For example, the memory 128 may include various types of dynamic random access memory (DRAM) such as SDRAM, the various types of static RAM (SRAM), and the various types of non-volatile memory (PROM, EPROM, and flash). In certain examples, the memory 128 is located on and/or co-located on the same computer chip as the processor 126. In the depicted embodiment, the memory 128 stores the above-referenced program 136 along with one or more stored values 138 (e.g., in various embodiments, a database of user information, such as past requests and/or preferences of the user).

The bus 134 serves to transmit programs, data, status and other information or signals between the various components of the computer system of the controller 118. The interface 130 allows communication to the computer system of the controller 118, for example from a system driver and/or another computer system, and can be implemented using any suitable method and apparatus. In one embodiment, the interface 130 obtains the various data from the transceiver 114, sensors 116, drive system 108, display 110, and/or other vehicle systems 111, and the processor 126 provides control for the processing of the user requests based on the data. In various embodiments, the interface 130 can include one or more network interfaces to communicate with other systems or components. The interface 130 may also include one or more network interfaces to communicate with technicians, and/or one or more storage interfaces to connect to storage apparatuses, such as the storage device 132.

The storage device 132 can be any suitable type of storage apparatus, including direct access storage devices such as hard disk drives, flash systems, floppy disk drives and optical disk drives. In one exemplary embodiment, the storage device 132 comprises a program product from which memory 128 can receive a program 136 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 128 and/or a disk (e.g., disk 140), such as that referenced below.

The bus 134 can be any suitable physical or logical means of connecting computer systems and components. This includes, but is not limited to, direct hard-wired connections, fiber optics, infrared and wireless bus technologies. During operation, the program 136 is stored in the memory 128 and executed by the processor 126.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 126) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 118 may also otherwise differ from the embodiment depicted in FIG. 1, for example in that the computer system of the controller 118 may be coupled to or may otherwise utilize one or more remote computer systems and/or other control systems.

Also as depicted in FIG. 1, in various embodiments the remote server 104 includes a transceiver 144, one or more human advisors 146, and a remote server controller 148. In various embodiments, the transceiver 144 communicates with the vehicle control system 112 via the transceiver 114 thereof, using the one or more communication networks 106.

Also in various embodiments, the human advisors 146 provide information and/or other services and/or assistance in response to the user's request. For example, in various embodiments, if a determination is made that a human advisor is required due to a relatively low AVR score pertaining to the initial processing of the request (e.g., due to a user repeating the request, or due to noisy and/or other conditions that may lead to difficulty in the processor's interpretation of the request), the human advisor 146 will help to further identify the nature of the request, and to provide information, assistance, and/or services for the user in response to the request.

Also in various embodiments, the remote server controller 148 helps to facilitate the processing of the request and the engagement and involvement of the human advisor 146. For example, in various embodiments, the remote server controller 148 may comprise, in whole or in part, the user request control system 119 (e.g., either alone or in combination with the vehicle control system 112 and/or similar systems of a user's smart phone, computer, or other electronic device, in certain embodiments). In certain embodiments, the remote server controller 148 may perform some or all of the processing steps discussed below in connection with the controller 118 of the vehicle 102 (either alone or in combination with the controller 118 of the vehicle 102), such as automatically generating an interpretation of the request, gathering additional information that may pertain to the request (e.g., sensor data pertaining to noise within the cabin 103, an indication as to whether the user has repeated the request, user data from a database, Internet connectivity problems, other technological impairments, and/or the context of the request), determining an automated processing recognition (AVR) score pertaining to the processing of the request, and selectively engaging the human advisor 146 to further process the request based on the AVR score, and so on.

In addition, in various embodiments, as depicted in FIG. 1, the remote server controller 148 includes a processor 150, a memory 152 with one or more programs 160 and stored values 162 stored therein, an interface 154, a storage device 156, a bus 158, and/or a disk 164 (and/or other storage apparatus), similar to the controller 118 of the vehicle 102. Also in various embodiments, the processor 150, the memory 152, programs 160, stored values 162, interface 154, storage device 156, bus 158, disk 164, and/or other storage apparatus of the remote server controller 148 are similar in structure and function to the respective processor 126, memory 128, programs 136, stored values 138, interface 130, storage device 132, bus 134, disk 140, and/or other storage apparatus of the controller 118 of the vehicle 102, for example as discussed above.

FIG. 2 is a flowchart of a process for utilizing an advisor to provide information or other services in response to a request from a user, in accordance with exemplary embodiments. The process 200 can be implemented in connection with the vehicle 102 and the remote server 104, and various components thereof (including, without limitation, the control systems and controllers and components thereof), in accordance with exemplary embodiments.

As depicted in FIG. 2, the process 200 begins at step 202. In certain embodiments, the process 200 begins when a vehicle drive or ignition cycle begins, for example when a driver approaches or enters the vehicle 102, or when the driver turns on the vehicle and/or an ignition therefor (e.g. by turning a key, engaging a keyfob or start button, and so on). In certain embodiments, the process 200 begins when the vehicle control system 112 (e.g., including the microphone 120 thereof), and/or the control system of a smart phone, computer, and/or other system and/or device, is activated. In certain embodiments, the steps of the process 200 are performed continuously during operation of the vehicle (and/or of the other system and/or device).

In various embodiments, user inputs are obtained (step 204). In various embodiments, the user inputs include a user request for information and/or other services. For example, in various embodiments, the user request may pertain to a request for information regarding a particular point of interest (e.g., restaurant, hotel, service station, tourist attraction, and so on), a weather report, a traffic report, to make a telephone call, to send a message, to control one or more vehicle functions, and/or any number of other potential requests for information and/or other services. Also in various embodiments, the request is obtained automatically via the microphone 120 of FIG. 1.

Also in various embodiments, a user database is retrieved (step 206). In various embodiments, the user database includes various types of information pertaining to the user. For example, in certain embodiments, the user database may include a history of past requests for the user, a list of preferences for the user (e.g., points of interest that the user commonly visits, other services often requested by the user, and so on). Also in various embodiments, the user database is stored in the memory 128 of FIG. 1 as stored values thereof, and is automatically retrieved by the processor 126 during step 206. In certain embodiments, the user database includes data and/or information regarding favorites of the user (e.g., favorite points of interest of the user), for example as tagged and/or otherwise indicated by the user, and/or based on a highest frequency of usage based on the usage history of the user, and so on. For example, in various embodiments, this would help reflect which points of interest and/or types of points of interest are used and/or visited more often than others. For example, if a user visits one particular type of restaurant, type of service station, brand of coffee shop, or the like, then this would be reflected as part of the user favorites information in the user database in certain embodiments, and so on.

The user request is interpreted (step 207). In various embodiments, the user request of step 204 is automatically interpreted by the processor 126 of FIG. 1 in order to attempt to ascertain the nature and specifics of the user request. In various embodiments, the processor 126 utilizes automatic voice recognition techniques to automatically interpret the words that were spoken by the user as part of the request. Also in various embodiments, the processor 126 also utilizes the user data database from step 206 in interpreting the request (e.g., in the event that the request has one or more words that are similar to and/or consistent with prior requests from the user as reflected in the user database, and so on).

In various embodiments, additional sensor data is also obtained (step 208). For example, in certain embodiments, the additional sensors 124 of FIG. 1 automatically collect data from or pertaining to various vehicle systems, such as the drive system and/or other vehicle systems 111 (e.g., one or more engines, more entertainment systems, climate control systems, window systems, and so on) that may generate, represent, and/or be indicative of a noise and/or sound level inside the cabin 103 of the vehicle 102, Internet connectivity problems and/or other technological impairments, and/or that otherwise may otherwise have an effect on the quality of the capture and/or recording of the user request by the microphone 120 of FIG. 1. In certain embodiments, the additional sensor data may be obtained via one or more cameras 123 of FIG. 1, for example, such as by scanning quick response (QR) codes to obtain names and/or other information pertaining to points of interest, and so on.

Also in various embodiments, initial information regarding the interpretation of the request is provided for the user (step 210). In various embodiments, the processor 126 automatically provides instructions for providing an initial identification of the interpretation of the request via the display 110 (e.g., visual information via a display screen and/or audio information via a speaker). For example, in certain embodiments, the initial identification of the interpretation may be an identification of the name of the particular point of interest that the user request has been interpreted as referring to, and/or a particular service that the user request has been interpreted as referring to, and so on.

In various embodiments, feedback is obtained from the user (step 212). For example, in certain embodiments, the microphone 120 of FIG. 1 (and/or in some embodiments, the other input sensors 122 of FIG. 1) obtain the user's reaction, if any, to the initial information from step 210. For example, in certain embodiments, the user may repeat the request if the interpretation is not deemed by the user to be correct. Also in some embodiments, the user may indicate an affirmative response (e.g., by stating “correct”, clicking on a “correct” box, or remaining silent, and so on, in different embodiments) if the interpretation is deemed by the user to be correct.

Also in various embodiments, a context of the request is ascertained (step 213). For example, in certain embodiments, the processor 126 automatically identifies any possible factors that may impede the smooth obtaining of the request from the user, for example based on the sensor data of step 208. For example, in certain embodiments, factors that may impede the smooth obtaining of the request from the user may include, among other possible factors, noise that may be caused by windows being open, operation of the engine, entertainment systems, and/or climate control systems, Internet connectivity problems and/or other technological impairments, and so on.

In various embodiments, an automated voice recognition (AVR) score is determined (step 214). In various embodiments, the AVR score is automatically calculated by the processor 126 of FIG. 1 based on the feedback (if any) of step 212, the other sensor data of step 208, and the context of step 213. For example, in certain embodiments, a relatively low AVR score is calculated or determined if the user has repeated his or her request, via the feedback of step 212. Also in certain embodiments, a relatively low AVR score is calculated or determined if the conditions are believed to be noisy within the cabin 103 of the vehicle 102. Also in certain embodiments, a relatively low AVR score is calculated or determined if conditions reflect poor Internet connectivity and/or other technological difficulties. Conversely, in certain embodiments, a relatively high AVR score is calculated or determined if the user has not repeated his or her request (and/or of the user has affirmatively indicated that the initial interpretation was correct), and the conditions are believed to not be noisy within the cabin 103 of the vehicle 102, and the conditions reflect working Internet connectivity and without other technological difficulties, and so on.

A determination is made as to whether engagement of a human advisor is required (step 216). In various embodiments, the processor 126 of FIG. 1 automatically determines that a human advisor is required if the AVR score is less than a predetermined threshold, which would indicate a lack of confidence in the initial interpretation of step 207.

If it is determined that an external advisor is required, then the external advisor is invoked (step 218). In various embodiments, the processor 126 of FIG. 1 automatically provides instructions to the human advisor 146 of FIG. 1 to further process the user request. In various embodiments, the instructions provided to the human advisor also include the content of the user request itself (e.g., so that the user does not need to repeat the request), along with the initial determination of step 210 (and along with any feedback from step 212). Also in various embodiments, the human advisor 146 provides a revised interpretation of the user request, for example based on the human advisor's 146 review of the user request, user database, initial determination, other sensor data, feedback, and context from steps 204-213, and, if necessary, based on direct communications between the human advisor 146 and the user. The process then proceeds to step 220, described below.

Conversely, if it is determined that an external advisor is not required, then the process proceeds directly to step 220 from step 216 in an automated manner, while skipping step 218 (i.e., without invoking the human advisor).

During step 220, the request is fulfilled. In various embodiments in which the human advisor was engaged in step 218, the human advisor 146 of FIG. 1 fulfills the request for the user. For example, in various embodiments, the human advisor 146 may identify a particular point of restaurant, provide directions and/or other information for the point of interest, make a telephone call, provide a message, control one or more vehicle systems, and/or provide any number of other services as requested by the user. Conversely, also in various embodiments, if the human advisor 146 was not engaged in step 218, then the request is fulfilled during step 220 in an automated manner, for example, using the processor 126 of FIG. 1.

Also in various embodiments, the user database is updated (step 224). Specifically, in various embodiments, the processor 126 of FIG. 1 automatically provides instructions for the user database in the stored values 138 of the memory 128 of FIG. 1 to be updated to reflect the revised interpretation from step 218 of the request, and including any differences between the revised interpretation of step 218 and the initial interpretation of step 207. Accordingly, the user database can effectively “learn” from any mistakes in this manner, for example in order to provide an improved response and interpretation the next time around, and so on.

In various embodiments, automation is restored or maintained (step 224). For example, in various embodiments, if the human advisor 146 was engaged, then automation is restored in step 244 by the processor 126. Conversely, also in various embodiments, if a human advisor 146 was not engaged, then automation is maintained in step 224. In various embodiments, the process 200 then terminates (step 226), for example until the vehicle 102 is re-started and/or until another request is made by the user.

Similar to the discussion above, in various embodiments some or all of the steps (or portions thereof) of the process 200 may be performed by the remote server controller 148, instead of or in addition to the vehicle control system 112 and/or vehicle controller 118. Accordingly, it will similarly be appreciated, with respect to the discussion of the process 200 above, that various steps performed by the processor 126 may also (or instead) be performed by the processor 150 of the remote server 104, and that references to the memory 128 may also pertain to the memory 152 of the remote server 104, and so on. Similarly, it will also be appreciated that various steps of the process 200 may be performed by one or more other computer systems, such as those for a user's smart phone, computer, tablet, or the like. It will similarly be appreciated that the systems and/or components of system 100 of FIG. 1 may vary in other embodiments, and that the steps of the process 200 of FIG. 2 may also vary (and/or be performed in a different order) from that depicted in FIG. 2 and/or as discussed above in connection therewith.

Accordingly, the systems, vehicles, and methods described herein provide for potentially improved processing of user request, for example for a user of a vehicle. Based on various parameters that may include user feedback and sensor data pertaining to expected noise in the vehicle, Internet connectivity, other technological issues, and/or other conditions for the user, an automated voice recognition (AVR) score is calculated for the user request. A human advisor is engaged when the calculated AVR score is less than a predetermined (e.g., when there is a diminished confidence in the initial interpretation of the user request as being correct).

The systems, vehicles, and methods thus provide for a potentially improved and/or efficient experience for the user in having his or her requests processed, for example while minimizing the need to repeat the request while increasing the probability of a correct interpretation of the user request. As noted above, in certain embodiments, the techniques described above may be utilized in a vehicle, such as an automobile, for example in connection with a touch-screen navigation system for the vehicle. Also as noted above, in certain other embodiments, the techniques described above may also be utilized in connection with the user's smart phones, tablets, computers, other electronic devices and systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via a microphone, a request from a user;
automatically generating, via a processor, an interpretation of the request;
automatically determining, via the processor, an automated processing recognition score for the request; and
automatically engaging, via instructions provided by the processor, a human advisor to further process the request, based on the determined automated processing recognition score.

2. The method of claim 1, further comprising:
automatically providing the request and the interpretation, via instructions provided by the processor, to the human advisor for further processing.

3. The method of claim 1, further comprising:
automatically providing initial information pertaining to the interpretation to the user via instructions provided by the processor; and
receiving feedback from the user regarding the initial information;
wherein the step of automatically determining the automated processing recognition score comprises automatically determining the automated processing recognition score using the feedback.

4. The method of claim 3, further comprising:
automatically determining that engagement of the human advisor is required if the feedback comprises the user repeating the request.

5. The method of claim 1, further comprising:
automatically obtaining, via one or more additional sensors, sensor data pertaining to one or more surrounding conditions for the user;
wherein the step of automatically determining the automated processing recognition score comprises automatically determining the automated processing recognition score based on the one or more surrounding conditions.

6. The method of claim 5, further comprising:
automatically determining that engagement of the human advisor is required if the one or more surrounding conditions represent noise that is greater than a predetermined threshold.

7. The method of claim 1, further comprising:
automatically retrieving, from a memory, a database of user information;
wherein the step of automatically generating the interpretation comprises automatically generating the interpretation using the user information; and
the method further comprises:
obtaining a revised interpretation from the human advisor; and
updating the database of user information based on the revised interpretation.

8. The method of claim 1, wherein the steps are implemented at least in part as part of a computer system for a vehicle in which the user is occupied.

9. A system comprising:
a microphone configured to obtain a request from a user; and
a processor configured to at least facilitate:
automatically generating an interpretation of the request;
automatically determining an automated processing recognition score for the request; and
automatically engaging a human advisor to further process the request, based on the determined automated processing recognition score.

10. The system of claim 9, wherein the processor is further configured to at least facilitate:
automatically providing instructions to provide the request and the interpretation to the human advisor for further processing.

11. The system of claim 9, wherein:
the processor is further configured to at least facilitate automatically providing instructions to providing initial information pertaining to the interpretation to the user;
the microphone is further configured to receive feedback from the user regarding the initial information; and
the processor is further configured to at least facilitate automatically determining the automated processing recognition score using the feedback.

12. The system of claim 11, wherein the processor is further configured to at least facilitate automatically determining that engagement of the human advisor is required if the feedback comprises the user repeating the request.

13. The system of claim 9, further comprising:
one or more additional sensors configured to at least facilitate automatically obtaining sensor data pertaining to one or more surrounding conditions for the user;
wherein the processor is further configured to at least facilitate automatically determining the automated processing recognition score based on the one or more surrounding conditions.

14. The system of claim 13, wherein the processor is further configured to at least facilitate automatically determining that engagement of the human advisor is required if the one or more surrounding conditions represent noise that is greater than a predetermined threshold.

15. The system of claim 9, further comprising:
a memory configured to store a database of user information;
wherein the processor is further configured to at least facilitate:
automatically retrieving, from the memory, the database of user information;
automatically generating the interpretation using the user information;
obtaining a revised interpretation from the human advisor; and
updating the database of user information based on the revised interpretation.

16. The system of claim 9, wherein the system at least in part is implemented as part of a computer system for a vehicle in which the user is occupied.

17. A vehicle comprising:
a passenger compartment for a user;
a microphone configured to obtain a request from the user; and
a processor configured to at least facilitate:
automatically generating an interpretation of the request;
automatically determining an automated processing recognition score for the request; and
automatically engaging a human advisor to further process the request, based on the determined automated processing recognition score.

18. The vehicle of claim 17, wherein:
the processor is further configured to at least facilitate automatically providing instructions to providing initial information pertaining to the interpretation to the user;
the microphone is further configured to receive feedback from the user regarding the initial information; and
the processor is further configured to at least facilitate:
automatically determining the automated processing recognition score using the feedback; and
automatically determining that engagement of the human advisor is required if the feedback comprises the user repeating the request.

19. The vehicle of claim 17, further comprising:
one or more additional sensors configured to at least facilitate automatically obtaining sensor data pertaining to one or more surrounding conditions for the user;
wherein the processor is further configured to at least facilitate:
automatically determining the automated processing recognition score based on the one or more surrounding conditions; and
automatically determining that engagement of the human advisor is required if the one or more surrounding conditions represent noise that is greater than a predetermined threshold.

20. The vehicle of claim 17, further comprising:
a memory configured to store a database of user information;
wherein the processor is further configured to at least facilitate:
automatically retrieving, from the memory, the database of user information;
automatically generating the interpretation using the user information;
obtaining a revised interpretation from the human advisor; and
updating the database of user information based on the revised interpretation.
